(19) United States
(12) Patent Application Publication
(10) Pub. No.: US 2003/0135405 A1
(43) Pub. Date: Jul. 17, 2003

(54) System, method, application to maximize electronic commerce and sales in retail automotive industry

(75) Inventors: Ronald D Townsend, Huntington Beach, CA (US); Sean Moore, Del Mar, CA (US)

Correspondence Address: PROCOPIO, CORY, HARGREAVES & SAVITCH LLP, 530 B STREET, SUITE 2100, SAN DIEGO, CA, 92101, US

(73) Assignee: VehNet, Inc.

(21) Appl. No.: 10/053,400

(22) Filed: Jan. 17, 2002

(51) Int. Cl. G06F 17/60

(52) U.S. Cl. 705/10

(57) ABSTRACT

A method of generating indefinite revenue streams in a retail industry includes automatically sending from a remote server a personalized action electronic communication to a client computer of a customer on every anniversary of a purchase date, the communication including questions for the customer; receiving at the client computer of a sales representative answers to the questions of the communication from the customer; generating indefinite revenue streams from the answers to the questions of the communication.

### FIELD OF THE INVENTION

The present invention relates in general to systems, methods, and applications for generating indefinite and multiple revenue streams, and maximizing electronic commerce and sales in any retail company, and, including, but not limited to, systems, methods, and applications for maximizing electronic commerce and sales in the retail automotive industry.

### BACKGROUND OF THE INVENTION

As with every retail industry, every dealer in the retail automotive industry would like to increase sales and service revenue. Every dealer would like to increase owner retention. Most dealers have expensive computer information systems that help them organize information and provide passive follow-up systems to each revenue-generating department.

As with any retail industry, Automobile Dealers have been searching for a more effective, and profitable, way to capture sales with interested prospects since Henry Ford came out with the Model T. Dealers have never realized the entire ownership experience of their customers. A vast source of net profit—sales, multiple channel revenues, and advertising/human resource expense reduction—has been left largely untapped through the dealership owner base, which contains as much as tens of thousands of owners.

Consumers have been searching for a stress-free, efficient, and enjoyable purchasing for decades. Because so much time, and emotional, capital is invested into the purchase ‘series’, consumers spend very little time thinking about the Dealer from which the vehicle was originally purchased (many times forgotten altogether within a few months). As long as the vehicle performs as advertised, is durable, maintenance needed only, and is aesthetically pleasing (for those where this is important), the memory of the Dealer for the majority of consumers becomes dim or non-existent.

To effectively compete in today's automotive market, dealers recognize that they must do a better job retaining and enhancing their owner base. Not only for the additional revenue stream, but, equally important, the expense reduction.

The average franchised automotive dealer can spend between $200-300 per sale in advertising alone, equaling $37,500 per month for the average mid-size dealer retailing 150 new and used vehicles per month.

The lost revenue streams by not retaining a high percentage of current owners are significant. Maintenance and warranty work on a customer's vehicle represents conservatively $100-200 gross profit during a three-year period. Excluding Lexus, Mercedes Benz, and BMW (which will have higher gross profit averages), most new and used vehicle sales generate between $2,000 and $2,500 gross profit for the average dealer, though the numbers can vary widely, most dealers will acknowledge the $2,000-2,500 threshold.

Based on a representative consumer buying or leasing two vehicles over a 6-8 year period, and the above criteria; a 10,000 dealer owner base represents an income stream of at least $48,000,000 Gross Profit, or $6,000,000 Gross Profit per year over 8 years, without adding any additional customers. The average Total dealership Gross Profit in 2000 was $3,713,954 (Source: Automotive New 2001 Market Date Book).

### SUMMARY OF THE INVENTION

This invention involves a method of generating indefinite revenue streams in any retail industry. In the case of the automotive industry, the method includes automatically sending from a remote server a personalized “action e-mail” to a client computer of a dealership customer on every monthly anniversary of an automotive vehicle purchase date. Besides thanking the customer for their patronage, the “action e-mail” includes specific questions for the dealership customer; these questions are highly targeted to requiring the customer to think of ways to refer Friends, Relatives, or Associates to the dealership for the purpose of buying a vehicle from the Dealer. These questions are in the form of Hyperlinks. Thus, there is a major convenience factor for the dealership customer, because no separate emails need to be initiated by the customer. The customer simply presses one of the question links and then is directed to a dealership-specific database in a vehicle referral system (“VRS”) application where the customer simply fills out referral name, address, phone, and other relevant information needed for contact by the dealer. The system does not require all of this information, besides the customer's name.

In this way, another end of this process, where the sales representative calls the customer only on the monthly anniversary date and at no other time during the month becomes mutually reinforcing. The reason for this is that frequently a customer will not know or remember all the relevant contact information about the referral, so the dealership sales representative can request this information on the monthly anniversary phone contact, or, if no phone contact, then via email. The “action e-mail” is sent early on the monthly anniversary date, or the day before, for each dealership customer. When the customer clicks on one of the hyperlink targeted questions, and fills out the information within the dealer specific and password only accessed referral questionnaire database section of the VRS application-driven software; the referral information is then immediately deposited in the relevant sales representative area in the system. When the sales representative accesses online his/her customers to be contacted that day, the system will automatically flag the sales representatives attention by showing which customer has referral waiting to be contacted.

Additionally, each “action e-mail” contains in the background a picture, or graphic or active-motion display, based on the individual customers hobbies or interests. The hobbies/interests are obtained from the customer when the vehicle is purchased. This information is inputted into VRS, which then applies the appropriate picture corresponding to the, or one of the, hobbies or interests listed by the customer at point of sale. This hobby/interest background graphic/display is an important part of the overall process, because it further engenders the customer's appreciation and trust of the email.

Studies have shown that permission based e-mail marketing generates a much higher response rate than direct mail. The present VRS process is two levels more advanced: It is company owner base electronic enhancement through familiarity, entertainment, synergized with a specific, and active customer-email-dealership representative interactive process.

The results are revenue streams on a tremendous scale never before seen.

One of the early hallmarks of the 21^{st}. Century is that consumers, especially American consumers, are living in an electronic entertainment society. Without an active entertainment factor, consumers quickly lose attention. In the online medium, when attention is lost, potential business is lost. However, the Internet also takes a degree of sociality out of the process, as human-human interaction is replaced by human-machine interaction. A significant aspect of the VRS method and process, for all industries, is that this active form of sales capture is comprised of a human-machine-human-human interaction where each phase is mutually reinforcing and mutually beneficial for both the customer and the company.

First, multiple recent studies and statistics have pointed to the fact that consumers have been far more comfortable purchasing online from a “recognized” source or brand name. What this has translated to is the need for consumers to purchase online from a recognized “Brick and Mortar” company, such a Sears or Wal-Mart, or one of the few online only Brand names, e.g. an Amazon.com or E-Bay. In the case of an automobile dealership, which definitely classifies as “Brick and Mortar”, and like many other companies, not a “brand name”, VRS gives them both. By giving the dealership or company both the “Brick and Mortar” (already existing) and the “brand name”, the present process and method gives the consumer and the company an exponentially greater benefit than they ever had before.

Second, existing follow-up models employed by companies utilize an electronic, telephone, or paper process, unless it is a company with a small prospect base where in-person follow-up procedure can be added. (Even with large sales staffs, this is typically an inefficient and time-consuming process). Many companies try to use all the follow-up processes at once, or mix-and-match, or use only one. However, not one company known by the inventors has a process that actively closes the consumer by first generating revenue for the company outside of the consumer, i.e. through another individual or entity. This is a new dynamic. Although with the present process, the original customer is not generating revenue by him or herself through the referral, multiple, not single, revenue streams are generated instantly. Because the VRS is an active, constant, entertaining, human-machine, and human-human interactive process, building and solidifying the relationship with the originating customer way beyond anything previously experienced.

The above method and process generates indefinite and multiple revenue streams for the retail industry, and greatly improves workflow efficiency and customer perception of the company in the process.

The method and process is preferably implemented using an Application Service Provider, making the method easy to use and very cost effective for dealerships because no expensive hardware or quickly outdated software is required to be purchased by the dealer. The method is initiated online and each company only needs Internet access and a standard web browser in order to utilize the method once the dealership owner base is in the system.

Further objects and advantages will be apparent to those skilled in the art after a review of the drawings and the detailed description of the preferred embodiments set forth below.

### BRIEF DESCRIPTION OF THE DRAWINGS

FIG. 1 is a schematic diagram of an embodiment of a 3-Tier architecture that may be used with the system, method, and application of the present invention.

FIG. 2 is a schematic diagram of an embodiment of a Model-View-Controller (MVC) design pattern that may be used to develop the system, method, and application of the present invention.

FIG. 3 is an exemplary embodiment of a customized image or interface a customer may see in an email sent to the customer based upon the customer selecting golf as one of the customer's hobbies and/or interests.

### DETAILED DESCRIPTION OF PREFERRED EMBODIMENTS

An embodiment of a system, method, and application for maximizing electronic commerce and sales in the retail automotive industry will now be described. It should be noted, although the system, method and application are described in conjunction with the retail automotive industry, the system, method, and application can be used to maximize electronic commerce and create indefinite revenue streams in any retail company or industry.

I. 1.0 Functional Overview

This invention involves a system, method, and application of generating indefinite revenue streams in any retail industry. In the case of the automotive industry, the method includes automatically sending from a remote server a personalized action electronic communication or “action e-mail” to a client computer of a dealership customer on every monthly anniversary of an automotive vehicle purchase date. Besides thanking the customer for their patronage, the “action e-mail” includes specific questions for the dealership customer; these questions are highly targeted to requiring the customer to think of ways to refer Friends, Relatives, or Associates to the dealership for the purpose of buying a vehicle from the Dealer. These questions are in the form of Hyperlinks. Thus, there is a major convenience factor for the dealership customer, because no separate emails need to be initiated by the customer. The customer simply presses one of the question links and then is directed to a dealership-specific database in the VRS application where the customer simply fills out referral name, address, phone, and other relevant information needed for contact by the dealer. The system does not require all of this information, besides the customer's name.

In this way, the other end of this invented business process, where the sales representative calls the customer only on the monthly anniversary date and at no other time during the month becomes mutually reinforcing. The reason for this is that frequently a customer will not know or remember all the relevant contact information about the referral, so the dealership sales representative can request this information on the monthly anniversary phone contact, or, if no phone contact, then via email. The “action e-mail” is sent early on the monthly anniversary date, or the day before, for each dealership customer. When the customer clicks on one of the hyperlink targeted questions, and fills out the information within the dealer specific and password only accessed referral questionnaire database section of the VRS application-driven software; the referral information is then immediately deposited in the relevant sales representative area in the system. When the sales representative accesses online his/her customers to be contacted that day, the system will automatically flag the sales representatives attention by showing which customer has referral waiting to be contacted. Additionally, each “action e-mail” contains in the background a picture, or graphic or active-motion display, based on the individual customers hobbies or interests. The hobbies/interests are obtained from the customer when the vehicle is purchased. This information is inputted into a vehicle referral system (“VRS”), which then applies the appropriate picture corresponding to the, or one of the, hobbies or interests listed by the customer at point of sale.

This hobby/interest background graphic/display is an important part of the overall process, because it further engenders the customer's appreciation and trust of the email. Studies have shown that permission based e-mail marketing generates a much higher response rate than direct mail. The present VRS process is two levels more advanced: It is company owner base electronic enhancement through familiarity, entertainment, synergized with a specific, and active customer-email-dealership representative interactive process.

II. 2.0 Architectural Overview

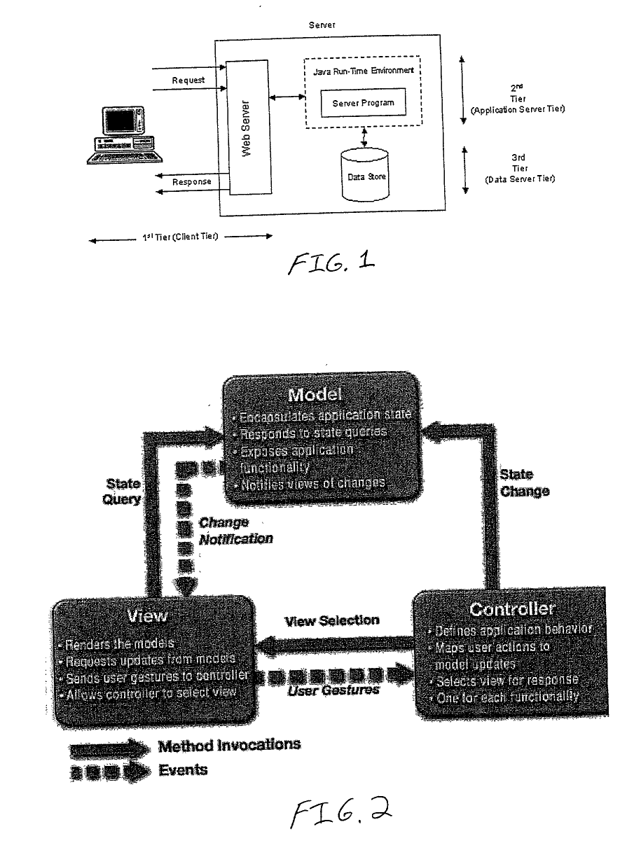

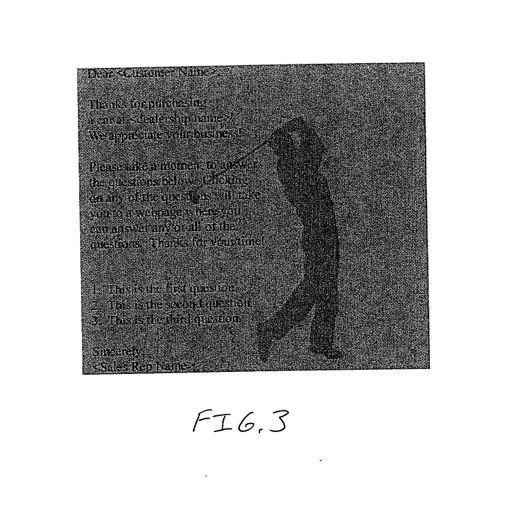

The system, method, and application may be implemented using a 3-tier architecture (FIG. 1), and may be developed using the Model-View-Controller (MVC) design pattern (FIG. 2). The 3-tier architecture and MVC pattern are described in detail below.

A. 2.1 3-Tier Architecture

1. 2.1.1 Client Tier

With reference to FIG. 1, the client tier may be responsible for the presentation of data, receiving user events and controlling the user interface. The actual business logic may reside within the application-server tier.

2. 2.1.2 Application Server Tier

Business-objects that implement the business rules may reside within the application server tier. This tier protects the data from direct access by the clients.

3. 2.1.3 Data-Server Tier

This tier may be responsible for data storage.

B. 2.2 MVC Pattern

1. 2.2.1 Model

With reference to FIG. 2, an embodiment of a Model-View-Controller (MVC) design pattern used to develop the system, method, and application of the present invention is shown. The model represents enterprise data and the business rules that govern access to and updates of this data. Often the model serves as a software approximation to a real-world process, so simple real-world modeling techniques apply when defining the model.

2. 2.2.2 View

A view renders the contents of a model. It accesses enterprise data through the model and specifies how that data should be presented. It is the view's responsibility to maintain consistency in its presentation when the model changes.

3. 2.2.3 Controller

A controller translates interactions with the view into actions to be performed by the model. In a stand-alone GUI client, user interactions could be button clicks or menu selections, whereas in a Web application, they appear as GET and POST HTTP requests. The actions performed by the model include activating business processes or changing the state of the model. Based on the user interactions and the outcome of the model actions, the controller responds by selecting an appropriate view.

III. 3.0 End-Users

A. 3.1 Description of an “End-User”

End-users of this application may be customers that respond to action e-mails, and users of the administration portion of the application, which may be employees.

B. 3.2 Browser

The following details the preferred browser configurations to use the application.

IE 4.0 or higher

Netscape Navigator 4.08 or higher.

Cookies must be turned on

C. 3.3 E-Mail Client

E-mail clients are preferably capable of reading HTML based e-mails so as to prevent the customer from receiving a garbled message.

D. 3.4 Display Requirements

The application will be built to display on an 800×600 screen resolution or higher.

IV. 4.0 Customer Interface

The customer interface portion of the application allows customers to respond to the questions contained in the e-mails that they have been sent.

A. 4.1 Action E-mail

The personalized action electronic communication may be a personalized e-mail that a customer may receive on the monthly anniversary of their purchase date. In alternative embodiments, the customer may receive the personalized e-mail on anniversaries other than monthly and/or from dates in addition to or alternative from the purchase date, e.g., the date the vehicle was last serviced. The e-mail is automatically generated at the application server level and is preferably sent to the customer at 6am PST on the monthly anniversary of their vehicle purchase date. Of course, the e-mail may be sent at alternative times. If the customer does not have a purchase date associated with their record in the database, a default date such as 1/1/2001 may be assigned. The e-mail may coincide with a monthly phone call from the sales representative currently assigned to this customer. The e-mail may be personalized according to the customer's interests and/or hobbies, and may rotate on a monthly basis depending on the number of hobbies and/or interests the customer has. If the interests and/or hobbies of a specific customer are not known, then a default type of email may be sent.

The personalized e-mails may include static graphics in the background (FIG. 3), or active graphics.

1. 4.1.1 E-mail Content

Each e-mail may contain a standard greeting where the only variables within the e-mail are “customer name”, “company name”, and “sales representative name” (see FIG. 3). All of these variables may be dynamically generated on a per-customer basis as the e-mails are generated at the server. Alternatively, the entire e-mail to be database driven, and be customized by the company administrator.

2. 4.1.2 E-Mail Questions

Each of the following three questions may be contained within the e-mail sent to each customer. Each of the questions may include a link back to a web page, where the customer may have the opportunity to answer as many questions as they feel inclined to answer (see 4.2). Automotive industry examples:

1. Who do you know of your friends and neighbors that are looking for a new or pre-owned car?

2. Who do you know of people at work, or business associates that are looking for a new or pre-owned car?

3. Who do you know of your family or relatives that is looking for a new or pre-owned car?

B. 4.2 Customer Response

Customers may arrive at this web page by clicking on one of the linked questions contained within the e-mail. The customer may be presented with a form that will allow the customer to enter information concerning the linked question has been clicked. There may be one “submit” button at the bottom of the page, that when clicked, may submit the information the customer has entered concerning the referral. After clicking the “submit” button, the customer may be presented with a “thank you” message, notifying the customer that their responses have been submitted, and thanking the customer for doing so. The customer may then be able to enter information concerning another referral, or the customer may have the choice to answer either of the other questions.

In an alternative embodiment, the system, method, and application may include a reward/response system that rewards customers for referring other customers.

The following specifications may apply to each question.

4.2.1 Question One

Question 1 may be as follows: Who do you know of your friends and neighbors that are looking for a new or pre-owned car?

Customers may be allowed to enter information on one referral at a time for this question.

The following information may be captured for this question (* denotes a required field):

1. Title (drop-down list box)*

2. First Name (text field—50 characters)*

3. Last Name (text field—50 characters)*

4. E-mail address (text field—50 characters)

5. Home phone area code (text field—3 characters)

6. Home phone prefix (text field—3 characters)

7. Home phone postfix (text field—4 characters)

8. Work phone area code (text field—3 characters)

9. Work phone prefix (text field—3 characters)

10. Work phone postfix (text field—4 characters)

11. Work phone extension (text field—7 characters)

12. Mobile phone area code (text field—3 characters)

13. Mobile phone prefix (text field—3 characters)

14. Mobile phone postfix (text field—4 characters)

15. Pager area code (text field—3 characters)

16. Pager prefix (text field—3 characters)

17. Pager postfix (text field 4 characters)

18. Other Information (text area)

19. Address 1 (text field—25 characters)

20. Address 2 (text field—25 characters)

21. City (text field—25 characters)

22. State (drop-down list box)

23. Zip Code 1 (text field—5 characters)

24. Zip Code 2 (text field—4 characters)

2. 4.2.2 Question Two

Question 2 may be as follows: Who do you know of people at work, or business associates that are looking for a new or pre-owned car?

Customers may be allowed to enter information on one referral at a time for this question.

The following information may be captured for this question (* denotes a required field):

1. Title (drop-down list box)*

2. First Name (text field—50 characters)*

3. Last Name (text field—50 characters)*

4. E-mail address (text field—50 characters)

5. Home phone area code (text field—3 characters)

6. Home phone prefix (text field—3 characters)

7. Home phone postfix (text field—4 characters)

8. Work phone area code (text field—3 characters)

9. Work phone prefix (text field—3 characters)

10. Work phone postfix (text field—4 characters)

11. Work phone extension (text field—7 characters)

12. Mobile phone area code (text field—3 characters)

13. Mobile phone prefix (text field—3 characters)

14. Mobile phone postfix (text field—4 characters)

15. Pager area code (text field—3 characters)

16. Pager prefix (text field—3 characters)

17. Pager postfix (text field 4 characters)

18. Other Information (text area)

19. Address 1 (text field—25 characters)

20. Address 2 (text field—25 characters)

21. City (text field—25 characters)

22. State (drop-down list box)

23. Zip Code 1 (text field—5 characters)

24. Zip Code 2 (text field—4 characters)

3. 4.2.3 Question Three

Question 3 may be as follows: Who do you know of your family or relatives that is looking for a new or pre-owned car?

Customers will be allowed to enter information on one referral at a time for this question.

The following information may be captured for this question (* denotes a required field):

1. Title (drop-down list box)*

2. First Name (text field—50 characters)*

3. Last Name (text field—50 characters)*

4. E-mail address (text field—50 characters)

5. Home phone area code (text field—3 characters)

6. Home phone prefix (text field—3 characters)

7. Home phone postfix (text field—4 characters)

8. Work phone area code (text field—3 characters)

9. Work phone prefix (text field—3 characters)

10. Work phone postfix (text field—4 characters)

11. Work phone extension (text field—7 characters)

12. Mobile phone area code (text field—3 characters)

13. Mobile phone prefix (text field—3 characters)

14. Mobile phone postfix (text field—4 characters)

15. Pager area code (text field—3 characters)

16. Pager prefix (text field—3 characters)

17. Pager postfix (text field 4 characters)

18. Other Information (text area)

19. Address 1 (text field—25 characters)

20. Address 2 (text field—25 characters)

21. City (text field—25 characters)

22. State (drop-down list box)

23. Zip Code 1 (text field—5 characters)

24. Zip Code 2 (text field—4 characters)

V. 5.0 Dealer Interface

The dealer interface portion of the system, method, and application may allow for administration of the system, method, and application as a whole, and on a more granular level, administration of actual customer records.

A. 5.1 Company Administration Roles

Company administration roles fall into four categories: SuperAdmin, AdminManager, SalesRep, and Basic. Each of these roles will be described in turn.

1. 5.1.1 SuperAdmin Role

There may be only one Super Administrator (“SuperAdmin”) account for the entire system, method, and application. The main purpose of the SuperAdmin is to manage the system, method, and application as a whole. The SuperAdmin may have the following privileges throughout the application:

1. The ability to add new dealerships to the application.

2. The ability to create AdminManager users for dealerships.

In an alternative embodiment, SuperAdmin users may have the ability to deactivate dealerships, and the ability to edit or delete AdminManager users.

2. 5.1.2 AdminManager Role

Each company may have at least one Administration Manager (“AdminManager”). The AdminManager role typically belongs to a senior manager within the company. The primary function of the AdminManager user is to manage SalesRep and Basic user accounts. AdminManager users may also have the ability to view all pertinent customer and referral information. AdminManagers may have the following privileges at the dealership level:

1. The ability to create or delete SalesRep, or Basic users.

2. The ability to assign customers to SalesRep users.

3. The ability to unassign customers from SalesRep users.

4. The ability to view all customers currently assigned to a specific SalesRep user.

5. Logged in as a SalesRep, the ability to view all referrals and the phone activity of the SalesRep.

In an alternative embodiment, Admin users may have the ability to add new hobbies/interests to the database.

3. 5.1.3 SalesRep Role

Each company may have one or more SalesRep users. A company Sales Representative (“SalesRep”) or Specialist is typically assigned as a SalesRep User. The primary function of the SalesRep is to manage and act on his/her customer records as well as new referral information. SalesReps have the following privileges at the company level:

1. The ability to view the customers that they need to contact on the current day, and that have been sent a personalized e-mail.

2. The ability to enter or edit information for a specific customer. The system automatically emails each customer on the designated monthly date, and then notifies the SalesRep of the customers scheduled to be contacted on that date, as well as referral responses to the email. The SalesRep can edit or add information such as appointments, deliveries, or follow-up notes in the phone log section for each customer.

3. The ability to view all customers currently assigned to them.

4. The ability to view and edit a customer's referrals.

In an alternative embodiment, the following additional functionality may be provided:

1. SalesRep users may be able to download the customers they need to contact for that day, to their PDA device.

4. 5.1.4 Basic User/Admin Support Role

Each dealership may have one or more Basic users or Admin. Support. The primary function of the Admin Support is to manually input user information captured during the car buying process into the database. Admin. Support has the following privileges at the company level:

1. The ability to create customer records.

In alternative embodiments, the Basic User input process may be automated or may not exist.

B. 5.2 SuperAdmin User Pages

There are two SuperAdmin user pages: 1) an Add New Company page, and 2) a Create AdminManager User page.

1. 5.2.1 Add New Company

This page may allow a SuperAdmin user to add a new company to the application. Information may be submitted by clicking the “submit” button at the bottom of the page.

The following information may be captured on this page (* denotes a required field):

1. Dealership Name (text field—50 characters)*

2. Dealership Address 1 (text field—50 characters)*

3. Dealership Address 2 (text field—50 characters)

4. Dealership City (text field—50 characters)*

5. Dealership State (drop-down list box)*

6. Dealership Zip Code 1 (text field—5 characters)*

7. Dealership Zip Code 2 (text field—4 characters)

2. 5.2.2 Create AdminManager User

This page may allow a SuperAdmin user to create an AdminManager user. Information may be submitted by clicking the “submit” button at the bottom of the page.

The following information may be captured on this page (* denotes a required field):

1. Username (text field—25 characters)*

2. Password (text field—15 characters)*

3. First Name (text field—50 characters)*

4. Middle Initial (text field—1 character)

5. Last Name (text field—50 characters)*

6. Work phone area code (text field—3 characters)*

7. Work phone prefix (text field 3 characters)*

8. Work phone postfix (text field 4 characters)*

9. Work phone extension (text field 7 characters)

10. Mobile phone area code (text field 3 characters)

11. Mobile phone prefix (text field 3 characters)

12. Mobile phone postfix (text field 4 characters)

13. E-mail address (text field—50 characters)

14. Pager (text field—10 characters)

C. 5.3 AdminManager User Pages

There are seven AdminManager user pages, each of which will be described below in turn.

1. 5.3.1 Create SalesRep User

This page may allow an Admin user to create a SalesRep user within the dealership with which the AdminManager is associated. Information may be submitted by clicking the “submit” button at the bottom of the page.

The following information may be captured on this page (* denotes a required field):

1. Username (text field—25 characters)*

2. Password (text field—15 characters)*

3. First Name (text field—50 characters)*

4. Middle Initial (text field—1 character)

5. Last Name (text field—50 characters)*

6. Work phone area code (text field—3 characters)*

7. Work phone prefix (text field 3 characters)*

8. Work phone postfix (text field 4 characters)*

9. Work phone extension (text field 7 characters)

10. Mobile phone area code (text field 3 characters)

11. Mobile phone prefix (text field 3 characters)

12. Mobile phone postfix (text field 4 characters)

13. Pager (text field—10 characters)

14. E-mail address (text field—50 characters)

2. 5.3.2 Delete SalesRep User

This page may allow an AdminManager user to delete a SalesRep user profile from the database. An example of when this may occur is if a SalesRep user terminates employment with the company. A record may be deleted by clicking the “delete” button next to the highlighted SalesRep user's full name. Before deleting the record, a javascript alert box may prompt the user to ensure they want to delete the record. If the user clicks “Yes”, the record will be deleted. If the user clicks “No”, the record will not be deleted.

The following information may be displayed on this page:

1. SalesRep user first and last name (drop-down list box).

3. 5.3.3 Assign Customers

This page may allow an AdminManager user to assign customers to specific SalesReps. SalesReps are selected by clicking the “select” button, next to the highlighted SalesRep user's full name. After selecting a SalesRep user, the page will reload and display a list of unassigned customers. Customers are assigned to SalesReps by highlighting the customer name and clicking the “assign” button at the bottom of the page. Multiple customers can be assigned to one SalesRep user at a time.

The following information may be displayed on this page:

1. SalesRep user first and last name (drop-down list box).

2. Customer names grouped by the first letter of their last name, and listed alphabetically by last name. The names will be displayed in a multiple select list box. If the customer has already been assigned to a SalesRep user, then their name will not be displayed. Below the multiple select list boxes will be the letters A-Z. By clicking on a letter, all customers that have a last name that begin with that letter will be displayed in the multiple select list box (multiple select list box).

In an alternative embodiment, the customer names may serve as links to the actual customer profiles. In an alternative embodiment, this function and the function described in 5.4.4 may be merged into one function.

4. 5.3.4 Unassign Customers

This page may allow an AdminManager user to unassign customers that have been assigned to a specific SalesRep user. SalesReps are selected by clicking the “select” button, next to the highlighted SalesRep user's full name. After selecting a SalesRep user, the page will reload and display a list of customers assigned to that SalesRep. Customers are unassigned from the selected SalesRep user by highlighting the customer name and clicking the “unassign” button at the bottom of the page. Multiple customers can be unassigned from one SalesRep user at a time.

The following information may be displayed on this page:

1. SalesRep user first and last name (drop-down list box).

2. Customer names grouped by the first letter of their last name, and listed alphabetically by last name. The names will be displayed in a multiple select list box. Below the multiple select list box will be the letters A-Z. By clicking on a letter, all customers that have a last name that begin with that letter will be displayed in the multiple select list box.

Future releases may allow the customer names to be links to the actual customer profiles. Future releases may also allow this and 5.4.3 to be merged into one function.

5. 5.3.5 Create Basic User

This page may allow an AdminManager user to create an admin. support within the company with which the AdminManager is associated. Information is submitted by clicking the “submit” button at the bottom of the page.

The following information may be captured on this page (* denotes a required field):

1. Username (text field—25 characters)*

2. Password (text field—15 characters)*

3. First Name (text field—50 characters)*

4. Middle Initial (text field—1 character)

5. Last Name (text field—50 characters)*

6. Work phone area code (text field—3 characters)*

7. Work phone prefix (text field 3 characters)*

8. Work phone postfix (text field 4 characters)*

9. Work phone extension (text field 7 characters)

10. Mobile phone area code (text field 3 characters)

11. Mobile phone prefix (text field 3 characters)

12. Mobile phone postfix (text field 4 characters)

13. E-mail address (text field—50 characters)

14. Pager (text field—10 characters)

6. 5.3.6 Delete Admin. Support

This page may allow an AdminManager user to delete a Admin. Support profile from the database. An example of when this may occur is if a Admin. Support terminates employment with the company. A record may be deleted by clicking the “delete” button next to the highlighted Admin. Support full name. Before deleting the record, a javascript alert box may prompt the user to ensure they want to delete the record. If the user clicks “Yes”, the record will be deleted. If the user clicks “No”, the record will not be deleted.

The following information is displayed on this page:

1. Basic user first and last name (drop-down list box).

7. 5.3.7 View all Customers Assigned to a Specific SalesRep

This page may allow an Admin user to view all customers that have been assigned to a specific SalesRep user. SalesReps are selected by clicking the “select” button, next to the highlighted SalesRep user's full name. After selecting a SalesRep user, the page may reload and display a table, containing a list of customers assigned to that SalesRep. Clicking on the customer name will return a table containing a list of that customer's referrals. The same information that is captured in 4.2.1 may be displayed in each table, for each customer and each referral.

The following information may be displayed on this page:

1. SalesRep user first and last name (drop-down list box)

2. Table containing either customer names or referral names. Below the table will be the letters A-Z. By clicking on a letter, all customers that have a last name that begin with that letter will be displayed in the table. Clicking on the customer name will return a table containing a list of that customer's referrals.

D. 5.5 SalesRep User Pages

There are five SalesRep user pages, each of which will be described in turn.

1. 5.5.1 View Customers Today

This page may allow a SalesRep user to view all customers that he or she is currently assigned to contact for the present day. The customer's full name may be a link to 5.5.2.

The following information may be displayed on this page:

1. Customer Full Name

2. Vehicle Owned

3. Customer E-mail Address

4. Customer Home Phone Number

5. Customer Work Phone Number

6. Customer Mobile Phone Number

2 5.5.2 Enter Information for Customers

This page may allow a SalesRep user to enter information for customers that he or she has just contacted. SalesRep users arrive at this page by clicking on the customer's full name displayed on 5.5.1. SalesRep users may have the ability to enter information for customers if customers have chosen not to respond to the questions by e-mail. Information is submitted by clicking the “submit” button at the bottom of the page.

The following information is displayed on this page:

1. Customer Title

2. Customer Full Name

3. Customer E-mail address

4. Customer Home Phone Number

5. Customer Work Phone Number

6. Customer Mobile Phone Number

7. Customer Pager Number

8. Customer Other Information

9. Customer Address

10. Customer City

11. Customer State

12. Customer Zip Code

13. Customer vehicle purchase date

The following information may be captured on this page:

1. Customer Hobbies/interests (checkboxes)

2. Customer Referrals

For each referral, the following information will be captured (* denotes required information):

Title (drop-down list box)*

First Name (text field—50 characters)*

Last Name (text field—50 characters)*

E-mail address (text field—50 characters)

Home phone area code (text field—3 characters)

Home phone prefix (text field—3 characters)

Home phone postfix (text field—4 characters)

Work phone area code (text field—3 characters)

Work phone prefix (text field—3 characters)

Work phone postfix (text field—4 characters)

Work phone extension (text field—7 characters)

Mobile phone area code (text field—3 characters)

Mobile phone prefix (text field—3 characters)

Mobile phone postfix (text field—4 characters)

Other Information (text area)

Address 1 (text field—25 characters)

Address 2 (text field—25 characters)

City (text field—25 characters)

State (drop-down list box)

Zip Code 1 (text field—5 characters)

Zip Code 2 (text field—4 characters)

3. Phone Contact Results (text area)

This field may allow reps to enter any extra information they deem necessary concerning the phone call they just had with the customer. i.e., attempted to contact customer, but nobody answered the telephone.

4. Customer contacted by phone (“Yes” or “No” radio button)

This field may coincide with the Phone contact results.

3. 5.5.3 View all Customers Assigned to them

This page may allow a SalesRep user to view all customers that have been assigned to them. They will have a link that when clicked will display a table containing a list of all customers currently assigned to them. Clicking on the customer name will return a table containing a list of that customer's referrals.

The following information may be displayed on this page:

1. Table containing either customer names or referral names. Below the table will be the letters A-Z. By clicking on a letter, all customers that have a last name that begin with that letter will be displayed in the table. Clicking on the customer name will return a table containing a list of that customer's referrals.

4. 5.5.4 Edit Customer Profile Information

This page may allow a SalesRep user to edit customer profile information for a specific customer. Information is submitted by clicking the “submit” button at the bottom of the page.

The following information may be displayed and captured on this page:

1. Title (drop-down list box)*

2. Customer First Name (text field—50 characters)*

3. Customer Middle Initial (text field—1 characters)

4. Customer Last Name (text field—50 characters)*

5. Vehicle Make (drop-down list box)*

6. Vehicle Model (drop-down list box)*

7. Vehicle Year (drop-down list box)*

8. Customer E-mail address (text field—50 characters)

9. Home phone area code (text field—3 characters)*

10. Home phone prefix (text field 3 characters)*

11. Home phone postfix (text field 4 characters)*

12. Work phone area code (text field—3 characters)*

13. Work phone prefix (text field 3 characters)*

14. Work phone postfix (text field 4 characters)*

15. Work phone extension (text field 7 characters)

16. Mobile phone area code (text field 3 characters)

17. Mobile phone prefix (text field 3 characters)

18. Mobile phone postfix (text field 4 characters)

19. Pager area code (text field—3 characters)

20. Pager prefix (text field—3 characters)

21. Pager postfix (text field 4 characters)

22. Month vehicle was purchased (drop-down list box)*

23. Day vehicle was purchased (drop-down list box)*

24. Year vehicle was purchased (drop-down list box)*

25. Hobbies/Interests (numerous checkboxes)

Hobbies/Interests are optional and only entered if this information was captured in the application filled out during the car buying process

26. Address 1 (text field—25 characters)

27. Address 2 (text field—25 characters)

28. City (text field—25 characters)

29. State (drop-down list box)

30. Zip Code 1 (text field—5 characters)

31. Zip Code 2 (text field—4 characters)

5. 5.5.5 Edit Referral Information

This page may allows a SalesRep user to edit referral information for a specific customer's referral. Information is submitted by clicking the “submit” button at the bottom of the page.

The following information is captured and displayed on this page:

1. Title (drop-down list box)*

2. First Name (text field—50 characters)*

3. Last Name (text field—50 characters)*

4. E-mail address (text field—50 characters)

5. Home phone area code (text field—3 characters)

6. Home phone prefix (text field—3 characters)

7. Home phone postfix (text field—4 characters)

8. Work phone area code (text field—3 characters)

9. Work phone prefix (text field—3 characters)

10. Work phone postfix (text field—4 characters)

11. Work phone extension (text field—7 characters)

12. Mobile phone area code (text field—3 characters)

13. Mobile phone prefix (text field—3 characters)

14. Mobile phone postfix (text field—4 characters)

15. Pager area code (text field—3 characters)

16. Pager prefix (text field—3 characters)

17. Pager postfix (text field 4 characters)

18. Other Information (text area)

19. Address 1 (text field—25 characters)

20. Address 2 (text field—25 characters)

21. City (text field—25 characters)

22. State (drop-down list box)

23. Zip Code 1 (text field—5 characters)

24. Zip Code 2 (text field—4 characters)

E. 5.6 Admin. Support Pages

There is one Admin. Support page, which will now be described.

1. 5.6.1 Create Customer Records

This page may allow a Admin. Support to manually input information into the database about customers that have purchased a car. The Admin. Support may look over the application that a customer fills out, and extracts the needed information. Future versions may automate this function.

The following information may be captured on this page (* denotes required information):

1. Title (drop-down list box)*

2. Customer First Name (text field—50 characters)*

3. Customer Middle Initial (text field—1 characters)

4. Customer Last Name (text field—50 characters)*

5. Vehicle Make (drop-down list box)*

6. Vehicle Model (drop-down list box)*

7. Vehicle Year (drop-down list box)*

8. Customer E-mail address (text field—50 characters)

9. Home phone area code (text field—3 characters)*

10. Home phone prefix (text field 3 characters)*

11. Home phone postfix (text field 4 characters)*

12. Work phone area code (text field—3 characters)*

13. Work phone prefix (text field 3 characters)*

14. Work phone postfix (text field 4 characters)*

15. Work phone extension (text field 7 characters)

16. Mobile phone area code (text field 3 characters)

17. Mobile phone prefix (text field 3 characters)

18. Mobile phone postfix (text field 4 characters)

19. Pager area code (text field—3 characters)

20. Pager prefix (text field—3 characters)

21. Pager postfix (text field 4 characters)

22. Month vehicle was purchased (drop-down list box)*

23. Day vehicle was purchased (drop-down list box)*

24. Year vehicle was purchased (drop-down list box)*

25. Hobbies/Interests (numerous checkboxes)

Hobbies/Interests are optional and only entered if this information was captured in the application filled out during the car buying process

26. Address 1 (text field—25 characters)

27. Address 2 (text field—25 characters)

28. City (text field—25 characters)

29. State (drop-down list box)

30. Zip Code 1 (text field—5 characters)

31. Zip Code 2 (text field—4 characters)

It will be readily apparent to those skilled in the art that still further changes and modifications in the actual concepts described herein can readily be made without departing from the spirit and scope of the invention as defined by the following claims.

What is claimed is:

1. A method of generating indefinite revenue streams in a retail industry, comprising the steps of:
automatically sending from a remote server a personalized action electronic communication to a client computer of a customer on every anniversary of a purchase date, the personalized electronic communication including questions for the customer;
receiving at a client computer of a sales representative answers to the questions of the personalized action electronic communication from the retail customer;
generating indefinite revenue streams from the answers to the questions of the personalized action electronic communication.

2. The method of claim 1, wherein an anniversary of a purchase date includes a monthly anniversary.

3. The method of claim 1, further including automatically sending from the remote server an electronic reminder to call the customer to a client computer of an sales representative on every monthly anniversary of an purchase date of the retail customer.

4. The method of claim 1, wherein the questions of the personalized action electronic communication include a link to a web page on a remote server.

5. The method of claim 1, wherein at least some of the answers to the questions of the personalized action electronic communication include customer referrals, and sales are generated from the customer referrals.

6. The method of claim 1, wherein the personalized action electronic communication is personalized in accordance with at least one of the interests and hobbies of the customer.

7. The method of claim 1, wherein the personalized action electronic communication includes an interest or hobby theme that varies with each personalized action electronic communication.

8. The method of claim 1, wherein the personalized action electronic communication includes at least a customer name, a retail establishment name, and a sales representative name.

9. The method of claim 1, wherein at least one of the questions of the personalized action electronic communication asks for potential new customers.

10. The method of claim 1, wherein the customer is rewarded for referring a customer.

11. The method of claim 1, further including providing a super administrator function to at least one of add new retail establishments and create administration manager users for retail establishments.

12. The method of claim 1, further including providing an administrative manager function to at least one of create or delete sale representatives or basic users, assign or unassign customers to sale representatives, and view all customers currently assigned to a sales representative.

13. The method of claim 1, further including providing a sales representative function to at least one of view customers that need to be contacted on a specific day and that have been sent a personalized action electronic communication, enter or edit information for a customer, view all customers currently assigned to a sales representative, and view or edit referrals of a customer.

14. The method of claim 1, further including providing a basic function to create customer records.

15. The method of claim 1, wherein the retail industry is the automotive retail industry.

16. The method of claim 1, wherein the personalized action electronic communication is an e-mail.
